(19) United States
(12) Patent Application Publication
(10) Pub. No.: US 2019/0251468 A1
(43) Pub. Date: Aug. 15, 2019

(54) Systems and Methods for Distributed Generation of Decision Tree-Based Models

(71) Applicant: Google LLC, Mountain View, CA (US)

(72) Inventors: Mathieu Guillame-bert, Bonstetten (CH); Olivier Teytaud, Antony (FR)

(21) Appl. No.: 16/271,064

(22) Filed: Feb. 8, 2019

Related U.S. Application Data
(60) Provisional application No. 62/628,608, filed on Feb. 9, 2018.

(51) Int. Cl. G06N 20/00

(52) U.S. Cl. CPC G06N 20/00

(57) ABSTRACT

The present disclosure provides systems and methods to generate exact decision tree-based models (e.g., Random Forest models) in a distributed manner on very large datasets. In particular, the present disclosure provides an exact distributed algorithm to train Random Forest models as well as other decision forest models without relying on approximating best split search.

### PRIORITY CLAIM

The present application is based on and claims priority to U.S. Provisional Application No. 62/628,608 having a filing date of Feb. 9, 2018. Applicant claims priority to and the benefit of U.S. Provisional Application No. 62/628,608 and incorporates U.S. Provisional Application No. 62/628,608 herein by reference in its entirety.

### FIELD

The present disclosure relates generally to machine learning. More particularly, the present disclosure relates to systems and methods to generate exact decision tree-based models (e.g., Random Forest models) in a distributed manner on very large datasets.

### BACKGROUND

Classification and regression problems can include predicting respectively the class or the numerical label of an observation using a collection of training labelled records. Decision Tree (DT) learning algorithms are a widely studied family of methods both for classification and regression. DTs have a great expression power (DT are universal approximators), they are fast to build, and they are highly interpretable. However, controlling DT overfitting is non-trivial.

DT bagging, DT gradient-boosting, and DT boosting are three successful solutions aimed to tackle the DT overfitting problem. These methods (which can be collectively referred to as Decision Forest (DF) methods) can include training collections of DTs. DF methods are state of the art for many classification and regression problems.

As well as DT learning algorithms, generic DF methods typically require a random memory access to the dataset during training. These methods are also non-directly computationally distributable: the cost of network communication exceeds the gain of distribution. These two constraints restrict the usage of existing DF methods to datasets fitting in the main memory of a single computer.

Two families of approaches have been studied and sometimes combined to tackle the problem of training Decision Trees (DT) and Decision Forests (DF) on large datasets: (i) Approximating the building of the tree by using a subset of the dataset and/or approximating the computation of the optimal splits with a cheaper or more easily distributable computation, and (ii) using different but exact algorithms (building the same models) that allow distributing the dataset and the computation. Various works have shown that (i) typically leads to bigger forests and lower precision.

### SUMMARY

Aspects and advantages of embodiments of the present disclosure will be set forth in part in the following description, or can be learned from the description, or can be learned through practice of the embodiments.

One aspect of the present disclosure is directed to a computer-implemented method. The method includes distributing a training dataset to a plurality of workers on a per-attribute basis, such that each worker receives attribute data associated with one or more attributes. The method includes generating one or more decision trees on a depth level-per-depth level basis. Generating the one or more decision trees includes performing, by each worker at each of one or more depth levels, only a single pass over its corresponding attribute data to generate a plurality of proposed splits of the attribute data respectively for a plurality of live nodes.

Another aspect of the present disclosure is directed to a computer-implemented method. The method includes obtaining, by one or more computing devices, a training dataset comprising data descriptive of a plurality of samples, respective attribute values for a plurality of attributes for each of the plurality of samples, and a plurality of labels respectively associated with the plurality of samples. The method includes partitioning, by the one or more computing devices, the plurality of attributes into a plurality of attribute subsets. Each attribute subset includes one or more of the plurality of attributes. The method includes respectively assigning, by the one or more computing devices, the plurality of attribute subsets to a plurality of workers. The method includes for each of a plurality of depth levels of a decision tree except a final level, where each depth level includes one or more nodes and for each of two or more of the plurality of attributes and in parallel: assessing, by the corresponding worker, the attribute value for each sample to update a respective counter associated with a respective node with which such sample is associated, wherein one or more counters are respectively associated with the one or more nodes at a current depth level; and identifying, by the corresponding worker, one or more proposed splits for the attribute respectively for the one or more nodes at the current depth level respectively based at least in part on the one or more counters respectively associated with the one or more nodes at the current depth level. The method includes for each of the plurality of depth levels of the decision tree except the final level, selecting, by the one or more computing devices, one or more final splits respectively for the one or more nodes at the current depth level from the one or more proposed splits identified by the plurality of workers.

Another aspect of the present disclosure is directed to a computer-implemented method. The method includes generating, by one or more computing devices, a decision tree with only a root. The method includes initializing, by the one or more computing devices, a mapping from a sample index to a node index. The method includes, for each of a plurality of iterations, receiving, by the one or more computing devices, a plurality of proposed splits from a plurality of splitters. The plurality of proposed splits is respectively generated based on a plurality of attributes of a training dataset. The method includes, for each of the plurality of iterations, selecting, by the one or more computing devices, a final split from the plurality of proposed splits. The method includes, for each of the plurality of iterations, updating, by the one or more computing devices, a node structure of the decision tree based at least in part on the selected final split. The method includes, for each of the plurality of iterations, updating, by the one or more computing devices, the mapping from the sample index to the node index based at least in part on the selected final split and the updated node structure. The method includes, for each of the plurality of iterations, broadcasting, by the one or more computing devices, the updated mapping to the plurality of splitters.

Another aspect of the present disclosure is directed to a computing system that includes one or more computing devices. The one or more computing devices are configured to implement: a manager computing machine; and a plurality of worker computing machines coordinated by the manager computing machine. The plurality of worker computing machines includes a plurality of splitter worker computing machines that have access to respective subsets of columns of a training dataset. Each of the splitter worker computing machines is configured to identify one or more proposed splits respectively for one or more attributes to which such splitter worker computing machine has access. The plurality of worker computing machines include one or more tree builder worker computing machines respectively associated with one or more decision trees. Each of the one or more tree builder worker computing machines is configured to select a final split from the plurality of proposed splits identified by the plurality of splitter worker computing machines.

Another aspect of the present disclosure is directed to a computer-implemented method. The method includes obtaining, by one or more computing devices, a training dataset comprising data descriptive of a plurality of samples, respective attribute values for a plurality of attributes for each of the plurality of samples, and a plurality of labels respectively associated with the plurality of samples. The method includes partitioning, by the one or more computing devices, the plurality of attributes into a plurality of attribute subsets, each attribute subset comprising one or more of the plurality of attributes. The method includes respectively assigning, by the one or more computing devices, the plurality of attribute subsets to a plurality of workers. The method includes, for each of a plurality of depth levels of a decision tree except an initial level and a final level, each depth level comprising a plurality of live nodes: for each of two or more of the plurality of attributes and in parallel: assessing, by the corresponding worker, the attribute value for each sample to update a respective counter associated with a respective node with which such sample is associated, wherein a plurality of counters are respectively associated with the plurality of live nodes at a current depth level; and identifying, by the corresponding worker, a plurality of proposed splits for the attribute respectively for the plurality of live nodes at the current depth level respectively based at least in part on the plurality of counters respectively associated with the plurality of live nodes at the current depth level. The method includes, for each of the plurality of depth levels of the decision tree except the initial level and the final level: selecting, by the one or more computing devices, a plurality of final splits respectively for the plurality of live nodes at the current depth level from the plurality of proposed splits identified by the plurality of workers.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system according to example embodiments of the present disclosure.

FIG. 2 depicts a block diagram of an example computing system according to example embodiments of the present disclosure.

FIG. 3A depicts a block diagram of an example computing system according to example embodiments of the present disclosure.

FIG. 3B depicts a block diagram of an example computing device according to example embodiments of the present disclosure.

FIG. 3C depicts a block diagram of an example computing device according to example embodiments of the present disclosure.

Reference numerals that are repeated across plural figures are intended to identify the same features in various implementations.

### DETAILED DESCRIPTION

1. Introduction

Example aspects of the present disclosure are directed to systems and methods to generate exact decision tree-based models (e.g., Random Forest models) in a distributed manner on very large datasets. In particular, the present disclosure provides an exact distributed algorithm to train Random Forest models as well as other decision forest models without relying on approximating best split search.

More particularly, two families of approaches have been studied and sometimes combined to tackle the problem of training Decision Trees (DT) and Decision Forests (DF) on large datasets: (i) approximating the building of the tree by using a subset of the dataset and/or approximating the computation of the optimal splits with a cheaper or more easily distributable computation, and (ii) using different but exact algorithms (i.e., algorithms that ultimately result in the same models) that allow distributing the dataset and the computation. Various works have shown that (i) typically leads to bigger forests and lower precision. The present disclosure focuses on the latter family of approaches: the present disclosure provides distributed systems and methods which results in models that are equivalent to those that would be obtained through performance of the original DT algorithm. However, the distributed nature of the systems and methods described herein allow them to be applied to extremely large datasets, which is not possible for the original DT or related algorithms.

According to an aspect of the present disclosure, a massive dataset can be distributed to a number of distributed and parallel workers. In particular, a computing system can distribute a training dataset to a plurality of workers on a per-attribute basis. For example, the training dataset can include data descriptive of a plurality of samples (e.g., organized into rows: one sample per row), respective attribute values for a plurality of attributes for each of the plurality of samples (e.g., organized into columns: one attribute per column, with each row of the column providing an attribute value for the corresponding sample), and a plurality of labels respectively associated with the plurality of samples (e.g., a final column that contains the labels for the samples). The computing system can partition and distribute the training dataset such that each worker receives attribute data associated with one or more attributes.

According to another aspect of the present disclosure, the computing system can generate one or more decision trees on a depth level-per-depth level basis. In some implementations, the computing system can generate (e.g., on a depth level-per-depth level basis) multiple decision trees in parallel. In other implementations, the computing system can sequentially generate multiple decision trees (e.g., one after the other). In yet further implementations, the computing system can generate only a single, stand-alone decision tree.

As one example technique for generating one or more decision trees on a depth level-per-depth level basis, the computing system can perform an iterative process to determine optimal splits of the nodes of the one or more trees at a current depth level, and then iteratively proceed to the next depth level. In particular, at each depth level, the workers can assess their respective attribute(s) and determine a proposed split for each attribute and for each live node at the current depth level. One or more tree builders responsible for building the one or more decision trees can receive the proposed splits from the workers and select a final, optimal split for each of the live nodes from the respective splits proposed for the nodes by the workers.

More particularly, according to another aspect of the present disclosure, at each depth level, each worker can perform only a single pass over its corresponding attribute data to generate a proposed split of its corresponding attribute data for each of a plurality of different nodes. Thus, during its single pass over its corresponding attribute data, each worker can generate proposed splits of the attribute data respectively for some or all of the live nodes at a current depth level. This is in contrast to certain existing techniques (e.g., the original DT algorithm), where a separate container of training data is generated for each node and the algorithm separately analyzes the data included in each container. This is also in contrast to certain existing techniques (e.g., SLIQ/R) which perform multiple passes over the attribute data on a node-by-node basis, rather than a single pass for all nodes.

In some implementations, a single worker can generate a respective proposed split for an attribute for live nodes across multiple trees. That is, in some implementations in which multiple trees are generated in parallel, a single worker can generate a proposed split of its attribute(s) for all live nodes at a current depth level in all trees (or a subset of all trees that includes two or more trees). In other implementations, each worker can generate a respective proposed split for an attribute for all live nodes in just a single tree. That is, in some implementations in which multiple trees are generated in parallel, a single worker can be assigned to each combination of tree and attribute and can generate respective proposed splits for the live nodes at the current depth level within its assigned tree. Thus, workers can be replicated in parallel and assigned to the same set of one or more attribute(s) but different trees to respectively generate proposed splits for such attribute(s) for multiple trees being generated in parallel. Other divisions of responsibility can be used as well. For example, a worker can work on several trees independently of each other.

As one example technique to generate proposed splits, at each depth level, each worker can determine whether each sample included in the training dataset in associated with one or more live nodes at the depth level. For example, in some implementations, each worker can use a shared seed-based bagging technique to compute a number of instances that a particular sample is included in a tree-specific training dataset associated with a given decision tree. Additionally or alternatively, the worker can consult a sample to node mapping to determine whether a sample is associated with a particular node.

For each sample associated with one or more live nodes of a current depth level, each worker can update one or more counters respectively associated with the one or more live nodes with which such sample is associated. In particular, the worker can update each counter based on the sample's attribute value(s) respectively associated with the attribute(s) associated with such worker.

As one example, for categorical attributes, each worker can update, for each live node, one or more bi-variate histograms between label values and attribute values respectively included in the one or more attributes associated with such worker.

As another example, for numerical attributes, each worker can sequentially and iteratively score, for each live node, proposed numerical splits of the attribute values respectively included in the one or more attributes associated with such worker.

After updating the respective counter(s) for its attribute(s) for each live node, each worker can generate a proposed split for each of the one or more live nodes at the depth level based on the counters. For example, the proposed split can be identified based on the final counter values.

At each depth level, one or more tree builders responsible for building the one or more decision trees can receive the proposed splits from the workers and select a respective final split for each of the live nodes. The tree builders can effectuate the selected final splits (e.g., generate children nodes for one or more of the live nodes and update the sample to node mapping based on the selected final split(s)), thereby generating a new depth level for the decision trees and restarting the iterative level building process. In some implementations, the updated sample to node mapping can be broadcasted to all of the splitter workers.

According to another aspect of the present disclosure, in some implementations, the sample to node mapping can be wholly stored in volatile memory (e.g., random access memory). In other implementations, the sample to node mapping can be distributed into a number of chunks and one or more of the chunks (e.g., the chunk currently being used by the worker(s)) can be stored in volatile memory while the other chunks (e.g., those not currently being used) can be stored in non-volatile memory (e.g., a disk drive). Thus, only a part of the mapping needs to reside in volatile memory at any instant, which advantageously provides lower volatile memory usage.

In the following sections, the present disclosure explains example systems, methods, and algorithmic implementations of the concepts described herein in further detail. In particular, among other examples, the present disclosure provides a distributed and exact implementation of Random Forest able to train on datasets larger than in any such past work, which can in some instances be referred to as “Distributed Random Forest” (DRF).

The methods described herein stand out from existing exact distributed approaches by a smaller space, disk and network complexity. In particular, various implementations of the present disclosure can provide the following benefits: (1) Removal of the random access memory requirement; (2) Distributed training (distribution even of a single tree); (3) Distribution of the training dataset (i.e. no worker requires access to the entire dataset); (4) Minimal number of passes in terms of reading/writing on disk and network communication; and/or (5) Distributed computing of feature importance.

U.S. Provisional Application No. 62/628,608, which is incorporated herein by reference, compares example implementations of the present disclosure to related approaches for various complexity measures (time, ram, disk, and network complexity analysis). Further, U.S. Provisional Application No. 62/628,608 reports their running performances on artificial and real-world datasets of up to 18 billion examples. This figure is several orders of magnitude larger than datasets tackled in the existing literature. U.S. Provisional Application No. 62/628,608 also empirically shows that Random Forest benefits from being trained on more data, even in the case of already gigantic datasets.

2. Example Distributed Random Forest Technique

This section describes a proposed Distributed Random Forest algorithm (DRF). The structure of the DRF algorithm is different from the classical recursive Random Forest algorithm; nonetheless, the proposed algorithm is guaranteed to produce the same model as RF.

The proposed method aims to reach: (1) Removal of the random access memory requirement. (2) Distributed training (distribution even of a single tree). (3) Distribution of the training dataset (i.e. no worker requires access to the entire dataset). (4) Minimal number of passes in terms of reading/writing on disk and network communication. (5) Distributed computing of feature importance. While the present disclosure mainly focuses on Random Forests, the proposed algorithm can be applied to other DF models, notably Gradient Boosted Trees (Ye et al., 2009).

Throughout this section, the DRF algorithm is generally compared to two existing methods that fall in the same category: Sprint (Shafer et al., 1996) and distributed versions of Sliq (Mehta et al., 1996).

DRF computation can be distributed among computing machines called “workers”, and coordinated by a “manager”. The manager and the workers can communicate through a network. DRF is relatively insensitive to the latency of communication (see, e.g., network complexity analysis in U.S. Provisional Application No. 62/628,608).

DRF can also distributes the dataset between workers: each worker is assigned to a subset of columns (most often) or sometimes a subset of rows (for evaluators or if sharding is added) of the dataset. Each worker only needs to read their assigned part of the dataset sequentially. Thus, according to an aspect of the present disclosure, no random access and no writing are needed. Workers can be configured to load the dataset in memory, or to access the dataset on drive/through network access.

Finally, each worker can host a certain number of threads. While workers communicate between each other through a network (with potentially high latency), it is assumed that the threads of a given worker have access to a shared bank of memory. Most of the steps that compose DRF can be multithreaded.

Several types of workers are responsible for different operations. The splitter workers look for optimal candidate splits. Each splitter has access to a subset of dataset columns. The tree builder workers hold the structure of one DT being trained (one DT per tree builder) and coordinate the work of the splitters. Tree builders do not have access to the dataset. One tree builder can control several splitters, and one splitter can be controlled by several tree builders.

The OOB evaluator workers evaluate continuously the out-of-bag (OOB) error of the entire forest trained so far. Each evaluator has access to a subset of the dataset rows.

The manager manages the tree builders and the evaluators. The manager is responsible for the fully trained trees. The manager does not have access to the dataset.

Unlike the generic DT learning algorithm, DRF builds DTs “depth level by depth level.” That is, all the nodes at a given depth are trained together. The training of a single tree is distributed among the workers. Additionally, as trees of a Random Forest are independent, DRF can train all the trees in parallel. DRF can also be used to train co-dependent sets of trees (e.g. Boosted Decision Trees). In this case, while trees cannot be trained in parallel, the training of each individual tree is still distributed.

The following subsections provide description of example implementations of and pseudocode for the DRF concepts.

2.1 Example Dataset Preparation

Presorting can be performed for numerical attributes. The most expensive operation when preparing the dataset is the sorting of the numerical attributes. In case of large datasets, this operation can be done using external sorting. In this phase, the manager distributes the dataset among the splitters. Each splitter is assigned with a subset of the dataset columns. In case several DTs are trained in parallel (e.g. RF), DRF benefits from having workers replicated. In particular, several workers can own the same part of the dataset and can be able to perform the same computation.

The first stage of the algorithm includes preparing the training set D={(x_{i,j}, yᵢ); i=1, . . . , n; j=1, . . . , m} where n is the number of samples, and m is the number of columns (also called attributes or features).

First, a unique dense integer index can be computed for each sample. If available, this index is simply the index i of the sample in the dataset. Next, the dataset can be re-ordered column-wise in increasing order of the sample indexes, and each column can be divided into p shards: For each column, the shard k contains the samples i ∈ [tₖ; tₖ₊₁] with tₚ₊₁=n. Finally, each numerical column can be sorted by increasing attribute value.

A sorted column can be a list of tuples <attribute value, label value, sample index, (optionally) sample weight>. The most expensive operation when preparing the dataset is the sorting of the numerical attributes. In case of large datasets, this operation can be done using external sorting.

2.2 Example Dataset Distribution

In this phase, the manager can distribute the dataset among the splitters and the evaluator workers. Each splitter can be assigned with a subset of the dataset columns, and each evaluator can be assigned with a subset of the dataset shards. In case several DTs are trained in parallel (e.g. RF), DRF benefits from having workers replicated i.e. several workers own the same part of the dataset and are able to perform the same computation.

2.3 Example Seeding

RF “bags” samples (i.e. sampling with replacement, n out of n records) used to build each tree. Instead of sending indices over the network, DRF can use a deterministic pseudorandom generator so that all workers agree on the set of bagged examples without network communication.

More particularly, for each tree, each sample i is selected bᵢ times with bᵢ sampled from the Binomial distribution corresponding to n trials with success probability 1/n. Pre-computing and storing bᵢ for each example is prohibitively expensive for large datasets.

Instead, in some implementations, DRF can compute bᵢ on the fly using a fast pseudo random generator function: bᵢ=bag(i, p) with i the sample index and p the tree index. bᵢ=bag(i, p) is a deterministic function. DRF can use an implementation of bᵢ=bag(i, p), for example, as proposed in Algorithm 6. This algorithm is a fixed number of steps of linear congruential generator that uses i and p as seeds. This implementation is a low quality random generator, but it is fast and sufficient for the bagging task.

Algorithm 6 Computation of bag(i, p)

a, b and m are three fixed large prime numbers, and n an integer
(e.g. n = 3).
k [symbol] cdf(k) is the cumulative distribution of the Binomial with n trials and
$probability success \frac{1}{n} , cdf ( k ) values are pre \text{-} computed for k ∈ [ 0 , K ]$
(e.g. K = 10).
c ← i
for k ← 0, . . . , n do c ← (ac + b) % m
c ← c + p
for k ← 0, . . . , n do c ← (ac + b) % m
υ ← c/m
for all k ← 0, . . . , K do
if υ ≤ cdf(k) then returns k
end for
returns K + 1

With this method, all workers are aware of the selected samples, without the cost of transmitting or storing this information. The random-access property removes the need for storing the samples in memory.

Similarly, Random Forest requires selecting a random subset of candidate attributes to evaluate at each node of each tree. Following the same method, DRF uses the deterministic function candidate (j, h, p), where candidate (j, h, p) specifies if the attribute j is considered for the node h of the tree p, and with candidate ( [symbol] , [symbol] , [symbol] ) following a binary distribution of success probability 1/\sqrt{d}.

2.4 Example Mapping of Sample Indices to Node Indices

At any point during training, each bagged sample is attached to a single leaf—initially the root node. When a leaf is derived into two children, each sample of this node is re-assigned to one of its child nodes according to the result of the node condition (condition=chosen split). In some implementations, DRF splitters and tree builders need to represent the mapping from a sample index to a leaf node.

DRF monitors the number [symbol] of active leaves (i.e., number of leaf nodes which can be further derived). Therefore, [log₂ [symbol] ] bits of information are needed to index a leaf If there is at least one non-active leaf, [log₂( [symbol] +1)] bits are needed to encode the case of a sample being in a closed leaf. Therefore, this mapping requires n[log₂( [symbol] +1)] bits of memory to store in which leaf each sample is.

Depending on the size of the dataset, this mapping can either be stored entirely in memory, or the mapping can be distributed among several chunks such that only one chunk is in memory at any time. The time complexity of DRF essentially increases linearly with the number of chunks for this mapping.

Unlike Sliq, DRF does not need to store the label values in memory.

2.5 Example Techniques for Finding the Best Split

During training, each splitter is searching for the optimal split among the candidate attributes it owns. The final optimal split is the best optimal split among all the splitters. The optimal split is defined as the split with the highest split score. As examples, either the Information Gain or the Gini Index can be used as split scores.

A split is defined as a column index j and a condition over the values of this column. For numerical columns, the condition is of the form x_{i,j}≤with τ ∈ [symbol] . For categorical columns, the condition is of the form x_{i,j} ∈ C with C ∈ 2^{S}^{ⱼ} and Sⱼ the support of column j. In case of attribute sampling (e.g. RF), only a random subset of attributes are considered. The super split can refer to a set of splits mapped one-to-one with the open leaves at a given depth of a tree.

The following subsections present examples of how DRF can compute the optimal splits for all the nodes at a given depth, i.e. the optimal super split at a given depth, in a single pass per feature. Computing optimal splits on categorical attributes is easily parallelized, whereas computing optimal splits in the case of numerical attributes needs presorting. These two cases are now discussed.

2.5.1 Categorical Attributes

Estimating the best condition for a categorical attribute j and in leaf h can include computing the bi-variate histogram between the attribute values and the label values for all the samples in h. The optimal (in case of binary labels) or approximate (in case of multiclass labels) split can then be identified using any number of techniques (see, e.g., L. Breiman et al., Classification and Regression Trees. Chapman & Hall, New York, 1984).

For a given categorical attribute j, given the mapping from the sample index to the open leaf index, a splitter computes this bi-histogram for each of the open leaves through a single sequential iteration on the records of the attribute j.

An example listing is given in Algorithm 7. The iteration over the samples can be trivially parallelized (multithreading over sharding).

Algorithm 7 Find the best supersplits for categorical attribute j and tree p.
Nodes are open when they are still subject to splitting - typically nodes are
closed when they reach some purity level or when their cardinal is below
some threshold.

H_{h∈[1,l]} is an empty bi-histogram between the labels and the attribute j for
the leaf l

| | |
|---|---|
| for all i in 1,...,n | // This loop can |
| | be parallelized do |

```
    h ← sample2node(i)
    if h is a closed node then continue
    if candidate feature(j,h,p) is false then continue
```

| | |
|---|---|
| B ← bag(i,p) | // Number of times i is |
| | sampled in tree p |

```
    if B = 0 then continue
    Add (x_{i,j},yᵢ) weighted by B to Hₕ
end for
for all open leaf h do
    Find best condition using bi-histogram Hₕ
end for
```

2.5.2 Numerical Attributes

Estimating the exact best threshold for a numerical attribute can include performing a sequential iteration over all the samples in increasing order of the attribute values.

Suppose q(k,j,h) the sample index of the kth element sorted according to the attribute j in the node h i.e. x_{q(0,j,h),j}≤x_{q(1,j,h)j}≤ . . . ≤x_{q(n}_{ₕ}_{-1,j,h),j}. During this iteration, the average of each two successive attribute values (x_{q(k,j,h),j}+x_{q(k+1,j,h),j})/2 is a candidate values for τ. The score of each candidate can be computed from the label values of the already traversed samples, and the label values of the remaining samples.

For a given numerical attribute j, given the mapping from the sample index to open leaf index, a splitter estimates the optimal threshold for each of the open leaves through a single sequential iteration on the records ordered according to the values of the attribute j. Since the records are already sorted by attribute values (see, e.g., section 2.1), no sorting is required for this step. One example listing is given in Algorithm 8.

Algorithm 8 Find the best supersplits for numerical attribute j and tree p

```
H_{h∈[1,l]} will be the histograms of the already traversed labels for the leaf l
(initially empty).
v_{h∈[1,l]} is the last tested threshold (initially null) for the leaf l.
q(j) is the list of records sorted according to the attribute j i.e. q(j) is a list
of tuples (a,b,i),
sorted in increasing order of a, where a is the numerical attribute value,
b is the label value, and i is the sample index.
{tₗ} will be the best τ for leaf l (initially null).
{sₗ} will be the score of tₗ (initially null).
for all (a,b,i) in q(j) do
  h ← sample2node(i)
  if h is a closed node then continue
  if candidate feature(j,h,p) is false then continue
  B ← bag(i,p)
  if B = 0 than continue
  τ ← (a + vₕ)/2
  s′ ← the score of τ (computed using Hₕ)
  if s′ > sₕ then
    sₕ ← s′
    tₕ ← τ
  end if
  Add yᵢ weighted by B to Hₕ for label b
  vₕ ← a
end for
return {tₗ} and {sₗ}
```

2.6 Example Technique for Training a Decision Tree

Each decision tree can be built by a tree builder. For example, Algorithm 9 provides one example technique for building a decision tree.

Algorithm 9 Tree builder algorithm for DRF.

| | |
|---|---|
| 1: | Create a decision tree with only a root. Initially, the root is the only open leaf. |
| 2: | Initialize the mapping from sample index to node index so that all samples are assigned to the |
| | root. |
| 3: | Query the splitters for the optimal supersplit. Each splitter returns a partial optimal supersplit |
| | computed only from the columns it has access to (using Alg. 8 in the case of numerical splits). |
| | The (global) optimal super split is chosen by the tree builder by comparing the answers of the |
| | splitters. |
| 4: | Update the tree structure with the optimal best supersplit. |
| 5: | Query the splitters for the evaluation of all the conditions in the best supersplit. Each splitter |
| | only evaluates the conditions it has found (if any). Each splitter sends the results to the tree |
| | builder as a dense bitmap. In total, all the splitters are sending one bit of information for each |
| | sample selected at least once in the bagging and still in an open leaf. |
| 6: | Compute the number of active leaves and update the mapping from sample index to node index. |
| 7: | Broadcast the evaluation of conditions to all the splitters so they can also update their sample |
| | index to node index mapping. |
| 8: | Close leaves with not enough records or no good conditions. |
| 9: | If at least one leaf remains open, go to step 3. |
| 10: | Send the DT to the manager. |

2.7 Example Technique for Training a Random Forest

To train a Random Forest, the manager queries in parallel the tree builders. This query contains the index of the requested tree (the tree index is used in the seeding, see, e.g., section 2.3) as well as a list of splitters such that each column of the dataset is owned by at least one splitter. The answer by the tree builder is the decision tree.

2.8 Example Technique for Continuous Out-of-Bag Evaluation

The Out-Of-Bag (OOB) evaluation is the evaluation of a RF on the training dataset, such that each tree is only applied on samples excluded from their own bagging. OOB evaluation allows evaluation of a RF without a validation dataset. Computing continuously the OOB evaluation of a RF during training is an effective way to monitor the training and detect the convergence of the model.

During training, after the completion of each DT (or as specified by a walltime), the manager can send the new trees to a set of evaluators such that, together, the set of evaluators covers the entire dataset (e.g., the dataset is distributed row-wise among the evaluators). Each evaluator then estimates the OOB evaluation of the RF on their samples. Evaluating bag(i, p) on the fly, evaluators can detect if a particular sample i was used to train a particular tree p. The partial OOB evaluation are then sent back to and aggregated by the manager. The same method can be used to compute the importance of each feature.

3. Example Complexity Analysis and Technical Effects and Benefits

U.S. Provisional Application No. 62/628,608 presents and compares in significant detail the theoretical complexities (memory, parallel time, I/O and network) of generic DT, generic RF, DRF, Sprint, Sliq, Sliq/R and Sliq/D. However, example technical effects and benefits of DRF and the main advantages of DRF over Sprint and Sliq/D-R are:

A smaller memory consumption per worker; e.g., compared to Sprint, DEF can reach, per worker, num records×(1+log₂ maxᵢ(num leaves at depth i)) bits, instead of num records×sizeof (record index) with sizeof (record index) equal to 64 bits for large datasets. Note: The memory consumption of DRF can be further reduced at the cost of an increase in time complexity.

A smaller amount and number of passes over data and of network communications. DRF's number of passes over data and network communication is proportional to the depth of the tree; while it is proportional to the number of nodes for Sprint, Sliq/D and Sliq/R. The total number of exchanged bits is also smaller for DRF. The network usage of Sliq/D is even greater since the node location of each sample is only known by one worker, and since all the workers need access to this information. DRF benefits from the communication efficient synchronous sample bagging schema (see, e.g., section 2.3).

Further, in the case of a large dataset, the data can be distributed in several machines, work-centers, countries, and/or continents. The algorithms proposed herein work nicely with this situation (e.g., because of the small number of back and forth communication between the workers). This also means that splitters can be distributed to be as close as possible to their data.

The absence of need for disk writing during training. DRF only writes on disk during the initialization phase (unless the workers are configured to keep the dataset in memory; in which case there are not disk writing at all). In comparison, during training, Sprint writes on disk the equivalent of several times the training dataset—for each tree in case of a forest.

All these algorithms operate differently, and benefit from different situations in term of time complexity:

Sprint prunes records in closed leafs: a tree with a large amount of records in shallow closed leafs is fast to train. However, Sprint scans and writes continuously both the candidate and non-candidate features i.e. Sprint does not benefit from the small size of the set of candidate features.

Compared to Sprint, DRF benefits from records being in closed leafs differently: records in closed leafs are not pruned, but since Sliq and DRF only scan candidate features (i.e. features randomly chosen and not closed in earlier conditions), a smaller number of records leads to a smaller number of candidate features. Although our experiments focus on the classical case of features randomly drawn at each node, we point out that Sliq and DRF benefit greatly (by a factor proportional to the number of features) from limiting the number of unique candidate features at a given depth. In particular, the trend consisting in using the same set of features for all nodes at a given depth leads to a fast DRF with a number of machines proportional to the number of randomly drawn features instead of the total number of features.

U.S. Provisional Application No. 62/628,608 also provides a study of the impact of equipping DRF with a mechanism to prune records similarly to Sprint: when DRF detects that this pruning becomes beneficial, the algorithm can prune the records in closed leafs. This operation is not triggered during the experimentation on the large dataset reported in U.S. Provisional Application No. 62/628,608.

4. Example Computing Systems and Devices

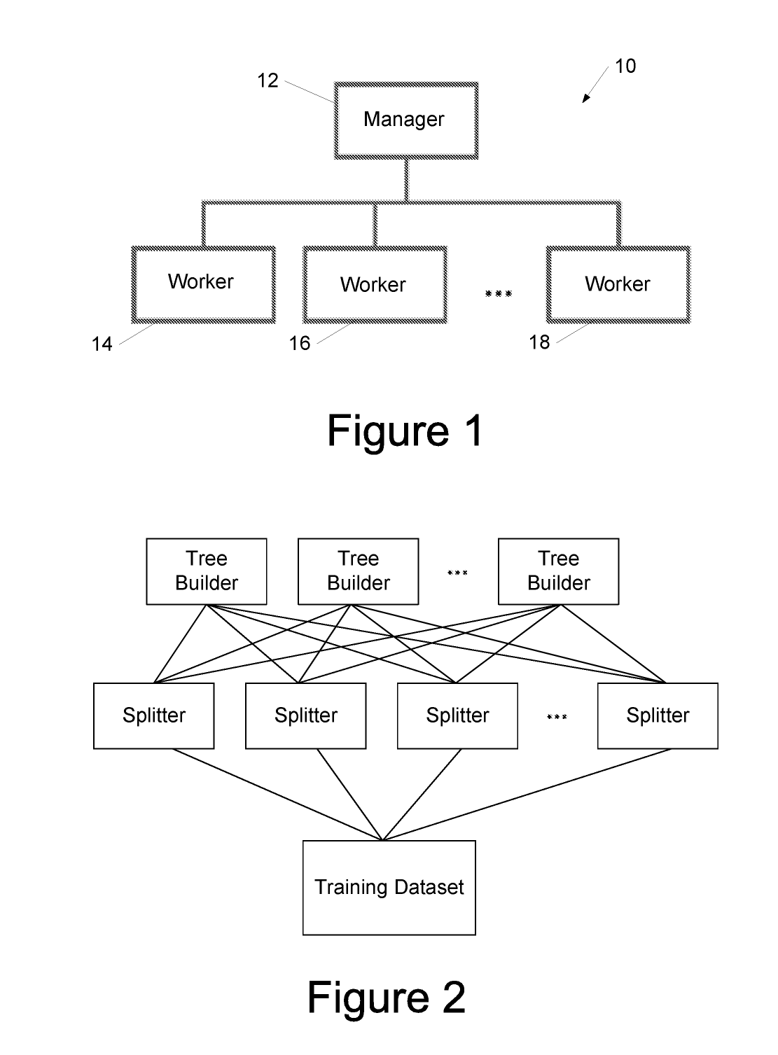

FIGS. 1-3C provide examples of computing systems and devices that can be used in accordance with aspects of the present disclosure. These computing systems and devices are provided as examples only. Many different systems, devices, and configurations thereof can be used to implement aspects of the present disclosure.

FIG. 1 depicts an exemplary distributed computing system 10 according to exemplary embodiments of the present disclosure. The architecture of the exemplary system 10 includes a single manager computing machine 12 (hereinafter “manager”) and multiple worker computing machines (e.g., worker computing machines 14, 16, and 18 (hereinafter “worker”). Although only three workers 14-18 are illustrated, the system 10 can include any number of workers, including, for instance, hundreds of workers with thousands of cores.

The workers 14-18 can include machines configured to perform a number of different tasks. For example, the workers 14-18 can include tree builder machines, splitter machines, and/or evaluator machines.

Each of the manager computing machine 12 and the worker computing machines 14-18 can include one or more processing devices and a non-transitory computer-readable storage medium. The processing device can be a processor, microprocessor, or a component thereof (e.g., one or more cores of a processor). In some implementations, each of the manager computing machine 12 and the worker computing machines 14-18 can have multiple processing devices. For instance, a single worker computing machine can utilize or otherwise include plural cores of one or more processors.

The non-transitory computer-readable storage medium can include any form of computer storage device, including RAM (e.g., DRAM), ROM (e.g., EEPROM), optical storage, magnetic storage, flash storage, solid-state storage, hard drives, etc. The storage medium can store one or more sets of instructions that, when executed by the corresponding computing machine, cause the corresponding computing machine to perform operations consistent with the present disclosure. The storage medium can also store a cache of data (e.g., previously observed or computed data).

The manager computing machine 12 and the worker computing machines 14-18 can respectively communicate with each other over a network. The network can include a local area network, a wide area network, or some combination thereof. The network can include any number of wired or wireless connections. Communication across the network can occur using any number of protocols.

In some implementations, two or more of the manager computing machine 12 and the worker computing machines 14-18 can be implemented using a single physical device. For instance, two or more of the manager computing machine 12 and the worker computing machines 14-18 can be virtual machines that share or are otherwise implemented by a single physical machine (e.g., a single server computing device).

In one exemplary implementation, each of the manager computing machine 12 and the worker computing machines 14-18 is a component of a computing device (e.g., server computing device) included within a cloud computing environment/system.

According to an aspect of the present disclosure, the manager 12 can act as the orchestrator and can be responsible for assigning work, while the workers 14-18 can execute the computationally expensive parts of the algorithms described herein. Both the manager 12 and workers 14-18 can be multi-threaded to take advantage of multi-core parallelism.

In some implementations, the manager manages workers that include tree builders and evaluators. The manager is responsible for the fully trained trees. In some implementations, the manager does not have access to the dataset.

FIG. 2 shows an example arrangement of worker computing machines. In particular, as illustrated in FIG. 2, the worker machines can include several types of workers that are responsible for different operations. The splitter workers can look for optimal candidate splits. Each splitter can have access to a subset of dataset columns. The tree builder workers can hold the structure of one DT being trained (one DT per tree builder) and can coordinate the work of the splitters. In some implementations, tree builders do not have access to the training dataset. One tree builder can control several splitters, and one splitter can be controlled by several tree builders.

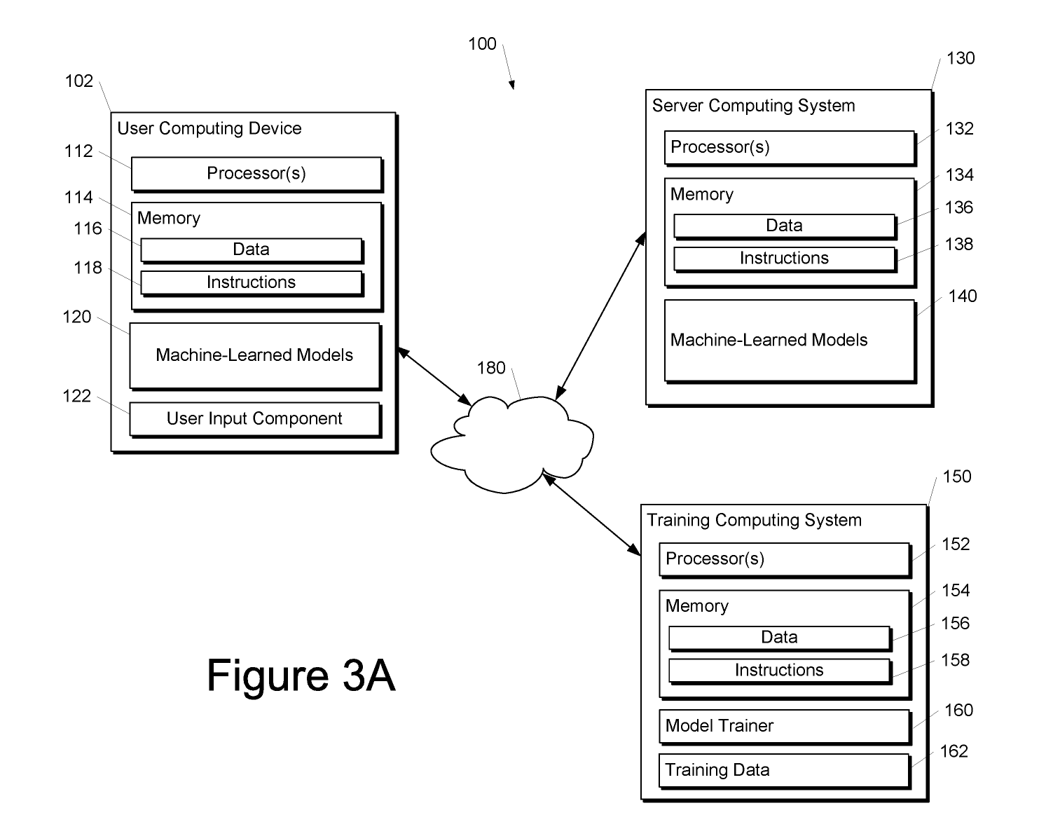

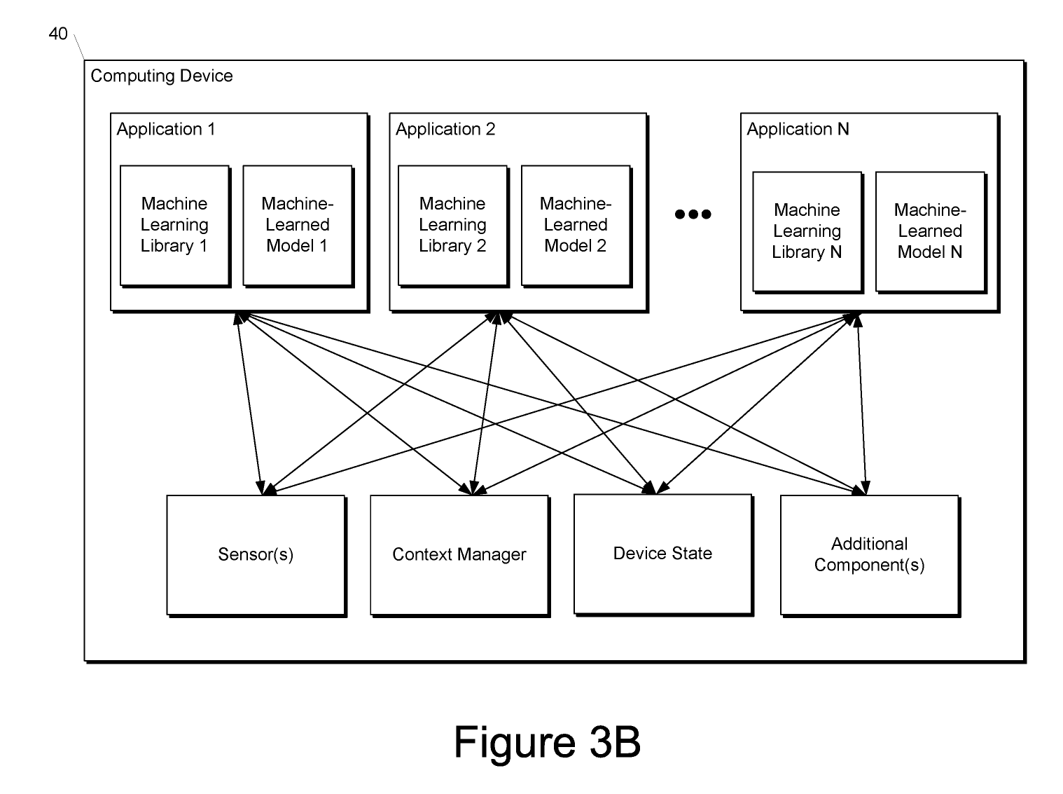

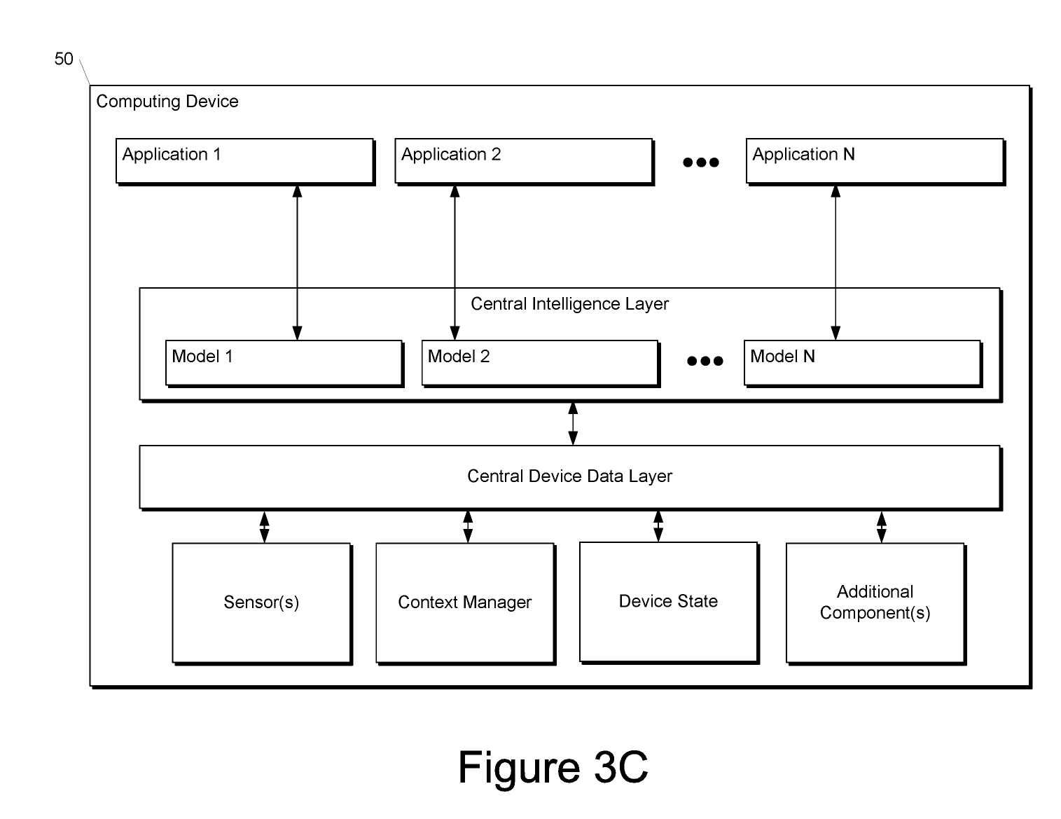

FIG. 3A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned decision-tree based models such as, for example, classification and/or regression trees; iterative dichotomiser 3 decision trees; C4.5 decision trees; chi-squared automatic interaction detection decision trees; decision stumps; conditional decision trees; etc. Decision tree-based models can be boosted models, random forest models, or other types of models.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned decision tree-based models such as, for example, classification and/or regression trees; iterative dichotomiser 3 decision trees; C4.5 decision trees; chi-squared automatic interaction detection decision trees; decision stumps; conditional decision trees; etc. Decision tree-based models can be boosted models, Random Forest models, or other types of models.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, any of the examples training techniques described herein, including, for example, DRF or variants thereof. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 142. The training data 142 can include, for example, data descriptive of a plurality of samples (e.g., organized into rows: one sample per row), respective attribute values for a plurality of attributes for each of the plurality of samples (e.g., organized into columns: one attribute per column, with each row of the column providing an attribute value for the corresponding sample), and a plurality of labels respectively associated with the plurality of samples (e.g., a final column that contains the labels for the samples). The training computing system 150 can partition and distribute the training dataset such that each worker receives attribute data associated with one or more attributes.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

In some implementations, the training computing system 150 can implement the model trainer 160 across or using multiple computing machines. For example, the model trainer 160 can take the form of the example systems illustrated in FIGS. 1 and 2.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 3A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 3B depicts a block diagram of an example computing device 40 that performs according to example embodiments of the present disclosure. The computing device 40 can be a user computing device or a server computing device.

The computing device 40 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 3B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 3C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 3C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 3C, the central device data layer can communicate with a number of other components of the computing device, such as, for example, one or more sensors, a context manager, a device state component, and/or additional components. In some implementations, the central device data layer can communicate with each device component using an API (e.g., a private API).

5. Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method comprising:
distributing, by one or more computing devices, a training dataset to a plurality of workers on a per-attribute basis, such that each worker receives attribute data associated with one or more attributes;
generating, by the one or more computing devices, one or more decision trees on a depth level-per-depth level basis, wherein generating the one or more decision trees comprises performing, by each worker at each of one or more depth levels, only a single pass over its corresponding attribute data to generate a plurality of proposed splits of the attribute data respectively for a plurality of live nodes; and
providing, by one or more computing devices, the one or more decision trees as an output.

2. The computer-implemented method of claim 1, wherein generating, by the one or more computing devices, one or more decision trees on a depth level-per-depth level basis comprises simultaneously generating, by the one or more computing devices, a plurality of depth trees on the depth level-per-depth level basis.

3. The computer-implemented method of claim 1, wherein performing, by each worker at each of the one or more depth levels, only the single pass over its corresponding attribute data to generate the plurality of proposed splits comprises performing, by each worker in parallel with all other workers, only the single pass over its corresponding attribute data to generate the plurality of proposed splits.

4. The computer-implemented method of claim 1, further comprising:
partitioning, by the one or more computing devices, the training dataset into a plurality of shards, each shard containing one or more samples; and
performing, by the one or more computing devices, out of bag evaluation of the one or more decision trees using the plurality of shards.

5. The computer-implemented method of claim 1, wherein performing, by each worker at each of the one or more depth levels, only the single pass over its corresponding attribute data to generate the plurality of proposed splits comprises performing, by each worker at each of the one or more depth levels, the single pass over its corresponding attribute data in a sequential fashion to generate the plurality of proposed splits.

6. The computer-implemented method of claim 1, wherein performing, by each worker at each of the one or more depth levels, only the single pass over its corresponding attribute data comprises:
at each depth level:
determining, by each worker, whether each sample included in the training dataset is associated with one or more of the plurality of live nodes at the depth level; and
generating, by each worker, the proposed split for each of the plurality of live nodes at the depth level, wherein the proposed split for each live node is based on the attribute data associated with samples that were determined to be associated with such live node.

7. The computer-implemented method of claim 1, wherein performing, by each worker at each of the one or more depth levels, only the single pass over its corresponding attribute data comprises:
at each depth level:
determining, by each worker, whether each sample included in the training dataset is associated with one or more of the plurality of live nodes at the depth level; and
for each sample associated with one or more of the live nodes, updating, by each worker, one or more counters respectively associated with the one or more live nodes with which such sample is associated based at least in part one or more attribute values respectively associated with the one or more attributes associated with such worker.

8. The computer-implemented method of claim 7, wherein updating, by each worker, the one or more counters respectively associated with the one or more live nodes comprises updating, by each worker and for each live node, one or more bi-variate histograms between label values and attribute values respectively included in the one or more attributes associated with such worker.

9. The computer-implemented method of claim 7, wherein updating, by each worker, the one or more counters respectively associated with the one or more live nodes comprises sequentially and iteratively scoring, by each worker and for each live node, proposed numerical splits of the attribute values respectively included in the one or more attributes associated with such worker.

10. The computer-implemented method of claim 7, wherein determining, by each worker, whether each sample included in the training dataset in associated with one or more live nodes at the depth level comprises using, by each worker, a shared seed to evaluate a bagging of each sample with respect to the one or more decision trees.

11. The computer-implemented method of claim 7, wherein determining, by each worker, whether each sample included in the training dataset in associated with one or more live nodes at the depth level comprises consulting a mapping from sample index to node index.

12. The computer-implemented method of claim 1, wherein the plurality of live nodes are included in a plurality of different decision trees of the one or more decision trees, such that each worker generates proposed splits of its attribute data for live nodes included in the plurality of different decision trees.

13. The computer-implemented method of claim 1, wherein the plurality of live nodes are included in a single decision tree of the one or more decision trees, such that each worker generates proposed splits of its attribute data for live nodes included in the single decision tree.

14. The computer-implemented method of claim 1, wherein generating the one or more decision trees further comprises:
performing, by each worker associated with a final split, a second pass over its corresponding attribute data to compute a bit condition associated with the final split.

15. A computer-implemented method, comprising:
obtaining, by one or more computing devices, a training dataset comprising data descriptive of a plurality of samples, respective attribute values for a plurality of attributes for each of the plurality of samples, and a plurality of labels respectively associated with the plurality of samples;
partitioning, by the one or more computing devices, the plurality of attributes into a plurality of attribute subsets, each attribute subset comprising one or more of the plurality of attributes;
respectively assigning, by the one or more computing devices, the plurality of attribute subsets to a plurality of workers; and
for each of a plurality of depth levels of a decision tree except a final level, each depth level comprising one or more nodes:
for each of two or more of the plurality of attributes and in parallel:
assessing, by the corresponding worker, the attribute value for each sample to update a respective counter associated with a respective node with which such sample is associated, wherein one or more counters are respectively associated with the one or more nodes at a current depth level; and
identifying, by the corresponding worker, one or more proposed splits for the attribute respectively for the one or more nodes at the current depth level respectively based at least in part on the one or more counters respectively associated with the one or more nodes at the current depth level; and
selecting, by the one or more computing devices, one or more final splits respectively for the one or more nodes at the current depth level from the one or more proposed splits identified by the plurality of workers.

16. The computer-implemented method of claim 15, wherein assessing, by the corresponding worker, the attribute value for each sample to update the respective counter associated with the respective node with which such sample is associated comprises:
sequentially across all of the plurality of samples:
determining, by the corresponding worker, whether the sample is associated with one of the one or more nodes at the current depth level; and
when the sample is associated with one of the one or more nodes at the current depth level, assessing, by the corresponding worker, the attribute value for the sample to update the respective counter associated with the respective node with which such sample is associated.

17. The computer-implemented method of claim 15, further comprising:
for each of a plurality of depth levels of the decision tree except the final depth level:
generating, by the one or more computing devices, two or more child nodes for at least one of the one or more nodes at the current depth level; and
updating, by the one or more computing devices, a mapping to assign at least one of the plurality of samples, wherein the assignment of samples to child nodes is performed according to the final split selected for the node from which the child nodes depend.

18. The computer-implemented method of claim 15, further comprising performing said steps of assessing, identifying, and selecting for each depth level of a plurality of decision trees in parallel.

19. The computer-implemented method of claim 18, further comprising:
providing, by the one or more computing devices, a plurality of random seeds to the plurality of workers, wherein the plurality of random seeds are respectively associated with the plurality of decision trees; and
for each decision tree:
for each of the plurality of depth levels of the decision tree except the final level and for each of the two or more of the plurality of attributes and in parallel:
using, by the corresponding worker, the corresponding random seed to determine a respective number of instances that each sample is included in a tree-specific dataset associated with the decision tree.

20. The computer-implemented method of claim 15, further comprising:
partitioning the training dataset into a plurality of shards, each shard containing one or more samples; and
performing out of bag evaluation of the one or more decision trees using the plurality of shards.

21. A computing system comprising one or more computing devices configured to implement:
a manager computing machine; and
a plurality of worker computing machines coordinated by the manager computing machine, wherein the plurality of worker computing machines comprise:
a plurality of splitter worker computing machines that have access to respective subsets of columns of a training dataset, wherein each of the splitter worker computing machines is configured to identify one or more proposed splits respectively for one or more attributes to which such splitter worker computing machine has access; and
one or more tree builder worker computing machines respectively associated with one or more decision trees, wherein each of the one or more tree builder worker computing machines is configured to select a final split from the plurality of proposed splits identified by the plurality of splitter worker computing machines.

22. The computing system of claim 21, wherein the plurality of worker computing machines further comprise one or more out-of-bag evaluator workers that have access to respective shards of rows of the training dataset and compute an out-of-bag error.
